(19) United States
(12) Patent Application Publication
(10) Pub. No.: US 2014/0041375 A1
(43) Pub. Date: Feb. 13, 2014

(54) Pneumatic Actuation Assembly

(71) Applicant: Confluent Surgical, Inc., Bedford, MA (US)

(72) Inventor: Les Hull, Attleboro, MA (US)

(73) Assignee: Confluent Surgical, Inc., Bedford, MA (US)

(21) Appl. No.: 13/922,640

(22) Filed: Jun. 20, 2013

Related U.S. Application Data
(60) Provisional application No. 61/681,706, filed on Aug. 10, 2012.

(51) Int. Cl. F15B 15/00

(52) U.S. Cl. CPC F15B 15/00
USPC 60/433

(57) ABSTRACT

An actuator assembly is provided. The actuator assembly includes housing configured for operable engagement by a user, a trigger assembly operably supported on the housing, a gas cartridge releasably secured to the housing, a valve assembly mounted within the housing for controlling the flow of pressurized gas through the housing and a cylinder actuator operably operably connected to the valve assembly. The cylinder actuator includes a piston selectively extendable therefrom configured for depressing a plunger. The piston includes a head having an inlet surface disposed within an inlet chamber of the cylinder actuator and an outlet surface disposed within the outlet chamber of the cylinder actuator. The exposed surface area of the first surface is equal to the exposed surface of the second surface.

### CROSS-REFERENCE TO RELATED APPLICATIONS

This application claims the benefit of and priority to U.S. Provisional Patent Application No. 61/681,706, filed Aug. 10, 2012, the entire disclosure of which is incorporated by reference herein.

### BACKGROUND

1. Technical Field

The present disclosure relates to applicator assemblies for mixing and dispensing components. More particularly, the present disclosure relates to pneumatic actuator assemblies for controlling the flow of the components through and from the applicator assembly.

2. Background of Related Art

Applicator assemblies for mixing and dispensing components are known. Many of these applicator assemblies include component filled syringes for supplying the components to a mixing assembly. One such applicator assembly is disclosed in commonly own U.S. Pat. No. 8,033,483, the content of which is incorporated herein by reference in its entirety. In use, a clinician manually depresses the plungers of the syringes to supply the components to the mixing assembly. When the syringes are manually actuated, the rate at which the mixed components flow through and from the applicator assembly tends to vary. Since many mixing assemblies require a specific rate to operate effectively, the inconsistent flow rate can be problematic.

To provide a more consistent flow of components through the applicator and to a surgical site, a surgeon may attach the applicator assembly to a powered actuator assembly configured for depressing the plungers of the syringes in a consistent and controlled manner. Some of these actuator assemblies are pneumatically-powered, such that when the assembly is actuated, e.g., a trigger is squeezed, compressed fluid, typically air from a gas cartridge, is supplied to a pneumatic cylinder actuator to cause a piston within the actuator to advance, thereby depressing the plungers of syringes in a consistent and controlled manner.

Although pneumatically powered actuator assemblies are know, these assemblies experience a phenomenon known as “coasting.” As will be discussed in greater detail below, the result of coasting is a continued flow of material from the applicator assembly after the actuator assembly has been deactivated, i.e., upon release of the trigger. Coasting may result in gooping, dribbling or other unwanted flow of the mixed components. As will also be discussed in greater detail below, coasting also prevents defined stops or boundaries when applying the mixed components.

Therefore, it would be beneficial to have an actuator assembly in which coasting is greatly reduced or eliminated altogether.

### SUMMARY

Accordingly, an actuator assembly is provided. The actuator assembly includes a housing configured for operable engagement by a user, a trigger assembly operably supported on the housing, a gas cartridge releasably secured to the housing, a valve housing mounted within the housing for controlling the flow of pressurized gas through the housing, and a cylinder actuator including a piston selectively extendable therefrom configured for depressing a plunger. The piston includes a head having an inlet surface disposed within an inlet chamber of the cylinder actuator and an outlet surface disposed within the outlet chamber of the cylinder actuator. The exposed surface area of the first surface is equal to the exposed surface of the second surface.

In some embodiments, the piston includes a first shaft extending from the inlet surface of the head and a second shaft extending from the outlet surface of the head. The piston may include a shaft extending through the head such that the shaft extends from both the inlet and outlet surfaces of the head. Alternatively, the cylinder actuator includes first and second sections and the piston includes a first head disposed within the first section and a second head disposed within the second section. A first shaft extends between the first and second heads and second shaft extends from the second head, wherein an exposed surface area of the first head is equal to an exposed surface area of the second head. The housing may be configured for operable connection with an applicator assembly. The valve housing may include at least a first actuator valve and at least a first dispense on/off valve. The valve housing may further include at least one solenoid valve. In some embodiments, the housing includes a pencil grip. Alternatively, the housing may include a pistol grip.

Also provided is a system including an applicator assembly and an actuator assembly. The applicator assembly includes at least one syringe having a plunger. The actuator assembly is configured for operable connection to the applicator assembly. The actuator assembly includes a cylinder actuator including a piston selectively extendable therefrom for depressing the plunger. The piston includes a head having an inlet surface disposed within an inlet chamber of the cylinder actuator and an outlet surface disposed within the outlet chamber of the cylinder actuator. The exposed surface area of the first surface and the second surface are equal.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a schematic diagram of an embodiment of an actuator assembly according to the present disclosure;

FIG. 2 is a graph showing the flow rate of mixed components exiting an applicator assembly that is actuated by the actuator assembly schematically illustrated in of FIG. 1;

FIG. 3 is top view of a splatter sheet resulting from the flow of mixed components from the applicator assembly illustrated in the graph of FIG. 2;

FIG. 4 is a schematic diagram of an actuator assembly according to another embodiment of the present disclosure;

FIG. 5 is a graph showing the flow rate of mixed components exiting an applicator assembly that is actuated by the actuator assembly schematically illustrated in FIG. 4;

FIG. 6 is a top view of a splatter sheet resulting from the flow of mixed components from the applicator assembly illustrated in the graph of FIG. 5;

FIG. 7 is a side view an actuator assembly according to another embodiment of the present disclosure schematically illustrating the components therein and including an applicator assembly operably attached thereto;

FIG. 8 is side view of an actuator assembly according to yet another embodiment of the present disclosure schematically illustrating the components therein and including an applicator assembly operably attached thereto; and

FIG. 9 is a schematic diagram of a cylinder actuator according to an embodiment of the present disclosure.

### DETAILED DESCRIPTION

Embodiments of the presently disclosed applicator assembly will now be described in detail with reference to the drawings in which like reference numerals designate identical or corresponding elements in each of the several views.

As discussed above, prior art pneumatically-powered actuator assemblies for use with applicator assemblies experience a phenomenon known as coasting. As will be discussed in further detail below, it has been determined that coasting occurs as a result of the reduced stopping force caused by the configuration of the piston head of the cylinder actuator.

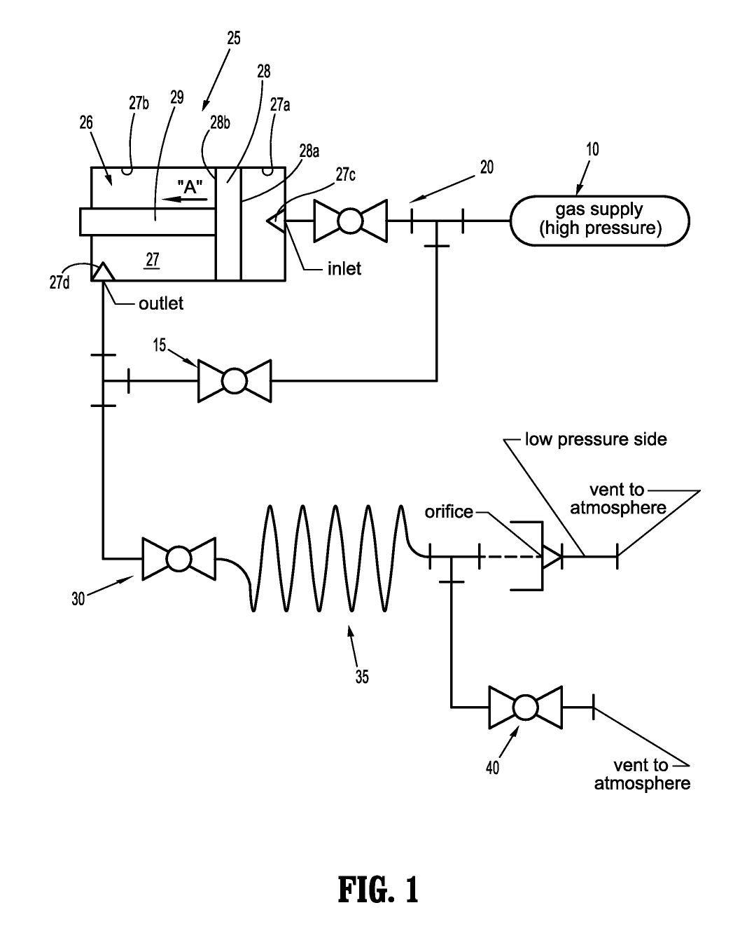

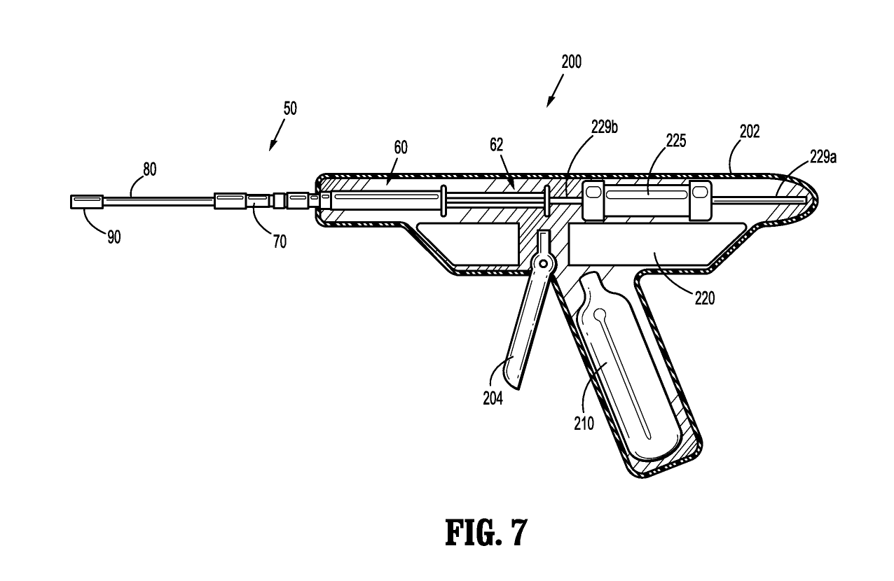

With reference to FIG. 1, a schematic diagram of a pneumatic actuator assembly according to a first embodiment of the present disclosure is shown generally as actuator assembly 1. Actuator assembly 1 includes a gas supply 10, a primary actuator charge valve 15, a secondary actuator charge valve 20, a single-ended actuator cylinder 25, a dispense on/off valve 30, an accumulator 35 and a solenoid valve 40. Single-ended actuator cylinder 25 is configured to depress a plunger 62 (FIG. 7) of an applicator assembly 50 (FIG. 7). Actuator cylinder 25 includes a piston 26 having a head 28 and a shaft 29. Actuator cylinder 25 defines a cavity 27. Head 28 of piston 26 divides cavity 27 of actuator cylinder 25 into an inlet chamber 27a and an outlet chamber 27b. Inlet chamber 27a includes an inlet 27c and outlet chamber 27b includes an outlet 27d. Head 28 of piston 26 includes an inlet surface 28a disposed within inlet chamber 27a and an outlet surface 28b disposed within outlet chamber 27b.

The operation of actuator assembly 1 will now be described with reference to FIG. 1. Prior to use, gas supply 10 is loaded into actuator assembly 1, if not already done so, and gas supply 10 is opened, i.e., a seal is punctured. Actuator cylinder 25 is then charged by opening primary actuator charge valve 15. Once actuator cylinder 25 is fully charged, primary actuator charge valve 15 is closed. Secondary actuator charge valve 20 remains open after charging. When fully charged, the pressure within each of inlet and outlet chambers 27a, 27b of actuator cylinder 25 are equal, as are the forces acting on head 28 of piston 26, therefore piston 26 is stationary.

To actuate single-ended actuator cylinder 25, dispense on/off valve 30 is opened, i.e., a trigger is squeezed. Opening of dispense on/off valve 30 permits pressurized gas to flow from outlet 27d in outlet chamber 27b of actuator cylinder 25 and pressurized gas to flow through inlet 27c of inlet chamber 27a of actuator cylinder 25 into inlet chamber 27a. As the pressurized air flows from outlet chamber 27b and into inlet chamber 27a, the difference in pressure acting on head 28 of piston 26 causes piston 26 to advance distally, in the direction of arrow “A”. Once dispense on/off valve 30 is closed, pressurized gas no longer flows from outlet chamber 27b through outlet 27d, and the pressure within outlet chamber 27b and the pressure within inlet chamber 27a equalize to prevent further advancement of piston 26. In this manner, piston 26 no longer depresses plunger 62 (FIG. 7) of applicator assembly 50 (FIG. 7), thereby stopping the flow of mixed components from the applicator assembly.

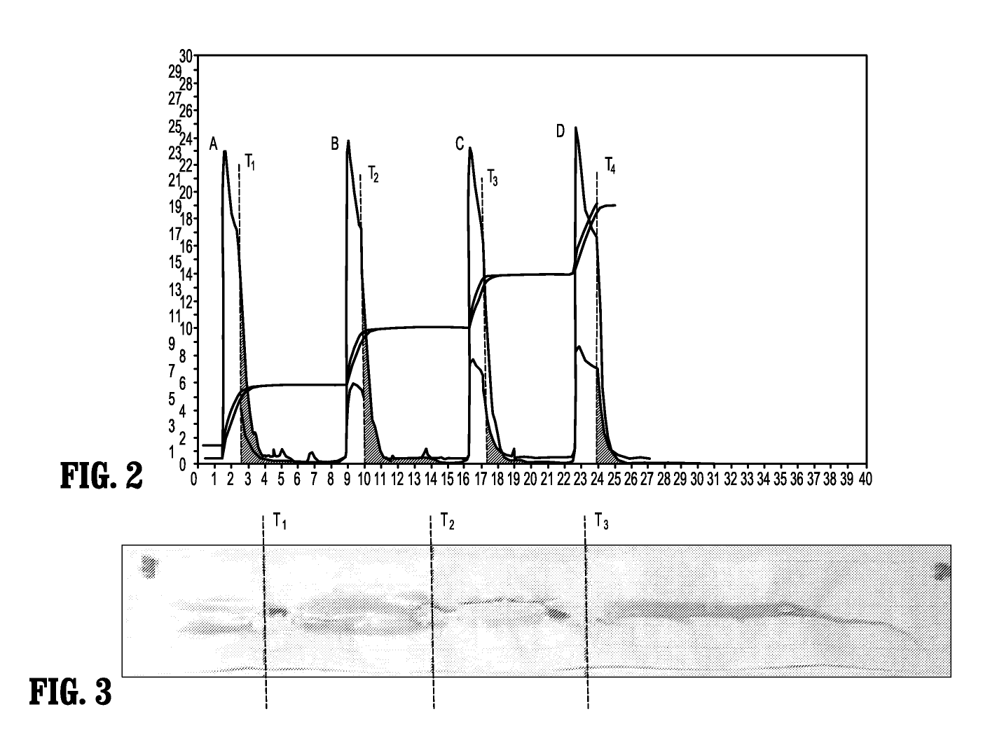

With reference to the graph of FIG. 2, tests were conducted to measure the rate of the mixed components flowing from an applicator assembly while using actuator assembly 1. During the test, actuator assembly 1 was actuated (started and stopped) four times (A, B, C, D). As seen in the graph of FIG. 2, the start of each actuation is represented by a substantially vertical line, which represents the nearly instantaneous flow of mixed components from the applicator assembly upon actuation of actuator assembly 1. First actuation (A) was stopped at a time T₁, second actuation (B) was stopped at a time T₂, third actuation (C) was stopped at a time T₃, and fourth actuation (D) was stopped at a time T₄. As can be seen in the graph, the time at which the mixed components ceased flowing, i.e., attained a flow rate of zero (0), lags from the time each actuation was stopped. The amount of mixed component that is dispensed after actuator assembly 1 is stopped is indicated by the shaded areas of the graph and is a result of the coasting that occurs within single-ended actuator cylinder 25.

A spray sheet created during the testing of actuator assembly 1 is shown in FIG. 3. As can be seen, there is no distinct boundary at the stop of each actuation. Instead, after each stoppage, mixed component continued to flow from the applicator assembly. As discussed above, this overflow may result in gooping and/or dribbling of the mixed component, thereby increasing the difficulty of performing a clean application of the mixed components.

Following testing, it was determined that the coasting in actuator assembly 1 occurs as a result of the reduced stopping force provided by outlet surface 28b of piston head 28. Specifically, the exposed surface area of outlet surface 28b, i.e., the area of piston head 28 disposed within outlet cavity 28b, is less then the exposed surface area of inlet surface 28a, i.e., the area of piston head 28 disposed within inlet cavity 28a. As seen in FIG. 1, the difference in exposed surface areas is caused by the surface area of distal surface 28b that is covered by shaft 29. The difference in exposed surface area of inlet and outlet surfaces 28a, 28b of head 28 of piston 26 results in there being less stopping force against outlet surface 28b subsequent to the closing of dispense on/off valve 30. The time it takes for forces acting on inlet surface 28a and outlet surface 28b of piston head 28 to equalize is the lag time, or length of time mixed components continue to flow from the applicator assembly.

Further testing found that by increasing the size of piston head 28 in relation to the diameter of shaft 29, the effect of coasting could be greatly reduced. It was also determined that although included, there was not a need for accumulator 35 on the first actuation of actuator assembly 1, as applicator assembly 50 (FIG. 7) had not yet been used, and actuator assembly 1 could operate effectively without accumulator 35 in the subsequent actuations despite the any obstructions caused by previous use. In use, accumulator 35 provides actuator assembly 1 with an initial burst of speed during actuation.

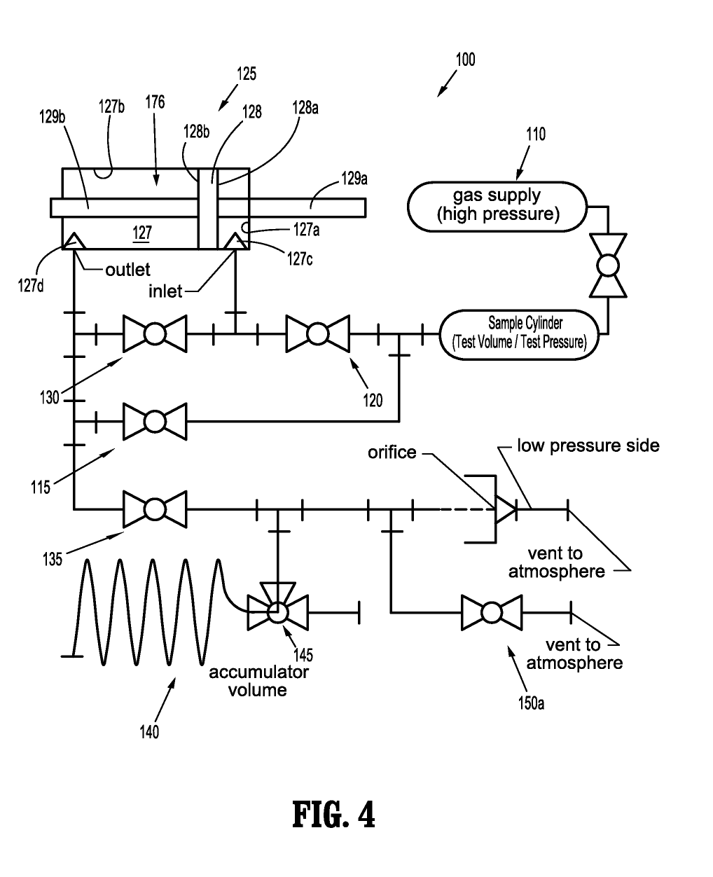

With reference now to FIG. 4, a schematic of an actuator assembly according to another embodiment of the present disclosure is shown generally as actuator assembly 100. Actuator assembly 100 includes a gas supply 110, a primary actuator charge valve 115, a secondary actuator charge valve 120, a double-ended actuator cylinder 125, a first solenoid valve 130 and a dispense on/off valve 135, and may optionally include an accumulator 40, an accumulator on/off valve 45 and a solenoid valve 50. Actuator assembly 100 is substantially similar to actuator assembly 1 and, therefore, will only be described as relates to the difference therebetween. Actuator assembly 100 includes a doubled-ended actuator cylinder 125 having a piston 126 including a head 128, a first shaft 129a extending from an inlet surface 128a of head 128 and a second shaft 129b extending from an outlet surface 128b of head 128.

During operation of actuator assembly 100, i.e., opening of dispense on/off valve 135, piston 126 is moved distally within cavity 127 of actuator cylinder 125 due to the flow of pressurized gas into inlet chamber 127a and out of outlet chamber 127b. Upon closing of dispense on/off valve 135, the flow of pressurized gas into inlet chamber 127a and out of outlet chamber 127b is stopped. Because each of inlet and outlet surfaces 128a, 128b of head 128 include shaft 129a, 129b, respectively, extending therefrom, the exposed surface areas of each of inlet and outlet surfaces 128a, 128b of head 128 are the same. As a result, the stopping force of outlet surface 128b is equal to the driving force against inlet surface 128a, thereby ceasing the advancement of piston head 128 immediately or almost immediately upon closing of dispense on/off valve 135. The equalization of the pressure within inlet and outlet chambers 127a, 127b may be further facilitated by solenoid valve 130 which is disposed between inlet 127c and outlet 127d of cylinder actuator 100 and is opened as dispense on/off valve 135 is closed.

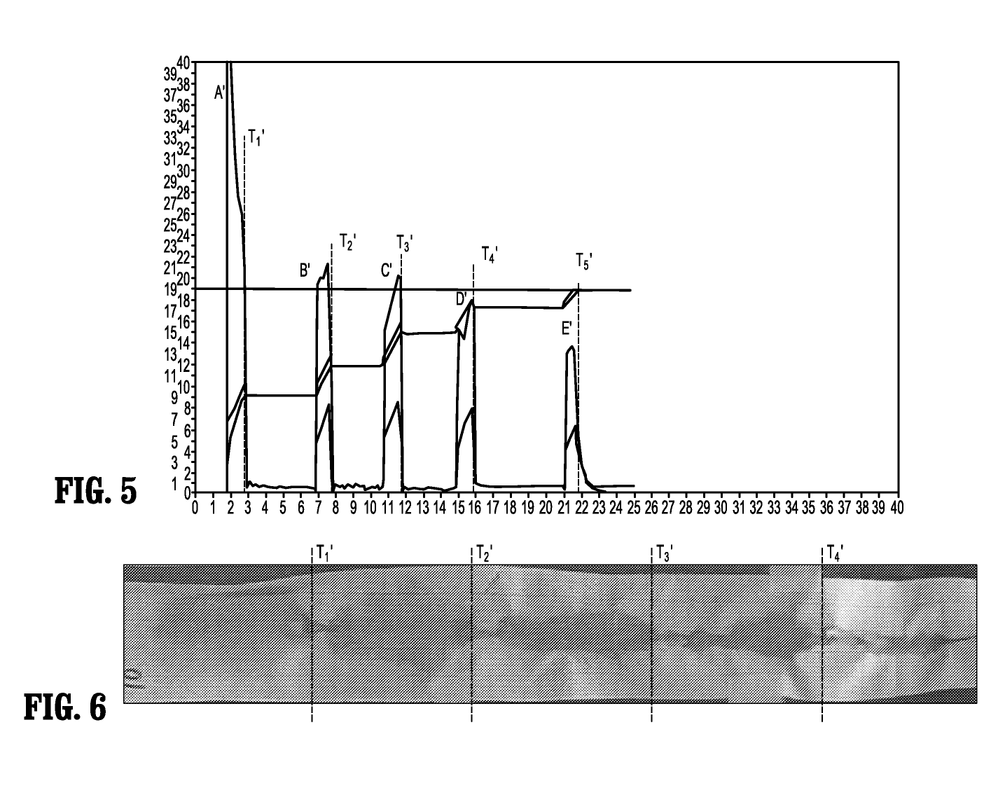

With reference to the graph in FIG. 5, tests similar to those discussed above with regards to actuator assembly 1 were conducted to measure the rate of the mixed components flowing from a similar applicator assembly while using actuator assembly 100. During the tests, actuator assembly 100 was actuated (started and stopped) five times (A′, B′, C′, D′, E′). Similar to the graph of FIG. 2, the start of each actuation is represented by a substantially vertical line which represents the nearly instantaneous flow of mixed components from the applicator assembly upon actuation of actuator assembly 100. First actuation (A′) was stopped at a time T₁′, second actuation (B′) was stopped at a time T₂′, third actuation (C′) was stopped at a time T₃′, fourth actuation (D′) was stopped at a time T₄′, and fifth actuation (E′) was stopped at a time T₅′. As can be seen in the graph, the time at which the mixed components ceased flowing, i.e., attained a flow rate of zero (0), occurs almost immediately upon deactivation of actuation assembly 100. The amount of mixed component that is dispensed after actuator assembly 100, as indicated by the area between the stop time and the line representing the flow rate, is nominal.

As with the previous test, a spray sheet was created during the testing of actuator assembly 100. As seen in the spray sheet shown in FIG. 6, there is a clear and distinct boundary at the stop of each actuation. As discussed above, the immediate or nearly immediate response achieved when using actuating the applicator assembly using actuation assembly 100 allows for a cleaner and more consistent application of mixed components.

As seen in the graph of FIG. 5, the flow rate of the first actuation is greater then the flow rate of the subsequent actuations. This is a result of applicator assembly 50 being unused, and therefore without any obstruction. As noted above, while included, testing showed that accumulator 135 was not necessary to the effective operation of actuator assembly 100.

With reference to FIG. 7, an embodiment of an actuator assembly according to the aspects of the present disclosure is shown generally as actuator assembly 200. Actuator assembly 200 includes a housing 202, a trigger assembly 204, a gas cartridge 210, a valve housing 220 and a double-ended cylinder actuator 225. As shown, housing 202 and trigger assembly 204 are in the form of a pistol grip. Although not shown, valve housing 220 includes one or more valves, i.e., solenoid, charge, dispense on/off, as discussed above for controlling the flow of pressurized gas through cylinder actuator 225. Housing 202 of actuator assembly 200 is configured to operably receive an applicator assembly 50. Applicator assembly 50 includes a source of components, i.e., syringes 60, a manifold 70, an elongated body 80 and a mixing/dispensing tip 90. Plunger 62 of syringes 60 are disposed adjacent to distal end of outlet shaft 229b of piston (not shown) of double-ended actuator 225. Syringes 60 and cylinder actuator 225 are arranged such that distal advancement of shaft 229b causes depression of plunger 62. Although the aspects of the present disclosure are being described for use with applicator assembly 50, it is envisioned that the aspects of the present disclosure may be modified for use with other applicator assemblies.

As discussed above, because actuator assembly 200 utilizes a doubled ended cylinder actuator 225, the surface areas of inlet and outlet surfaces (not shown) of head (not shown) of piston (not shown) are equal, therefore the equalization in pressure of inlet and outlet chambers (not shown) is nearly immediate. Thus, any coasting that was previously experienced as a result of differing exposed surface areas of the piston head is eliminated in actuator assembly 200, as the exposed surface areas of the piston head in double-ended cylinder actuator 225 are the same. Actuator assembly 200 may also include a solenoid (not shown) disposed between the inlet and the outlet to further assist in the immediate equalization of the pressure in the inlet chamber and the outlet chamber.

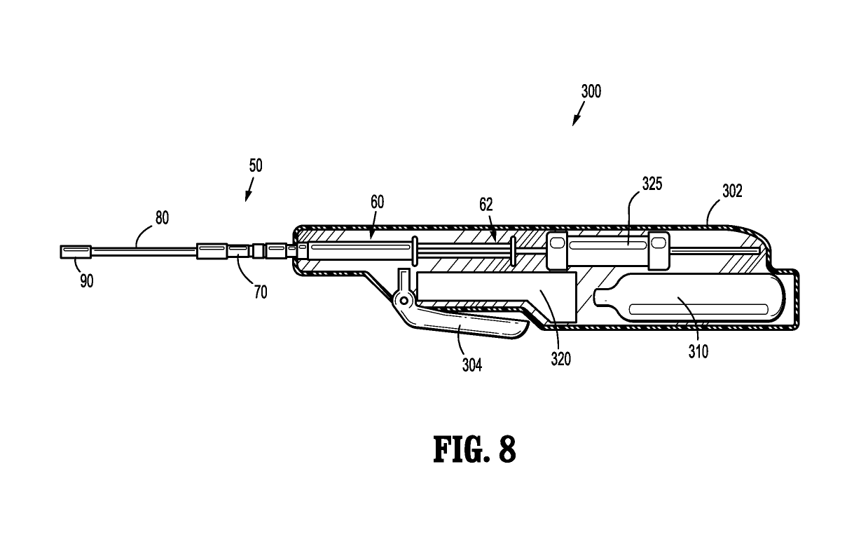

Turning to FIG. 8, another embodiment of an actuator assembly according to the present disclosure is shown generally as actuator assembly 300. Actuator assembly 300 is substantially similar to actuator assembly 200 in form and function. Actuator assembly 300 includes a housing 302 and a trigger assembly 304 in the form of a pencil grip. Actuator assembly 300 further includes a gas cartridge 310, a valve housing 320 and a double-ended cylinder actuator 325. Applicator assembly 50 is operably connected to housing 302 of actuator assembly 300.

Either or both of actuator assemblies 200, 300 may include indicators (not shown) for indicating the amount of pressurized gas remaining in respective gas cartridges 210, 310, the amount of component remaining in respective syringes 60, the flow rate of the components from applicator assembly 50, and/or any other various conditions that may be monitored during the use of actuator assemblies 200, 300.

As discussed above, the coasting within actuator assembly 1 was caused by the difference in surface area between the inlet surface and the outlet surface of the head of the piston. As also discussed above, one solution to this problem was addressed by adding a shaft to the inlet surface of the piston head such that each of the inlet and outlet surfaces of the head includes shaft 129a (FIG. 4). Shaft 129a functions solely as a space holder to make equal the exposed surface areas of inlet surface 128a and outlet surface 128b of piston head 128.

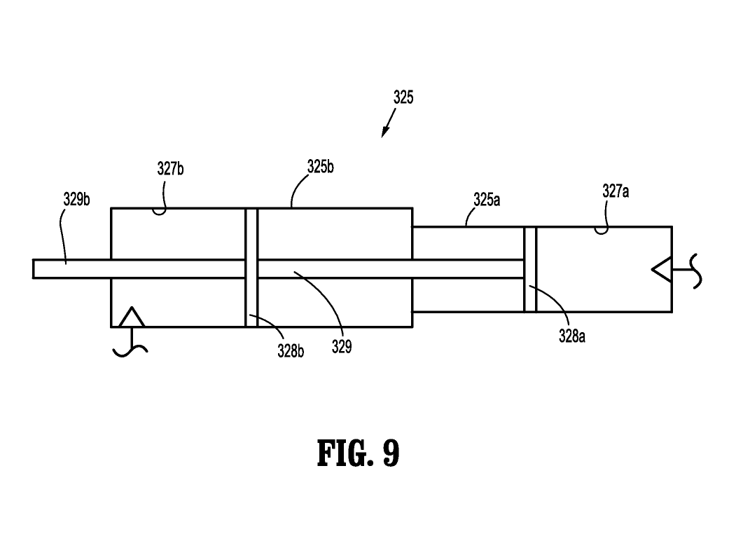

With reference to FIG. 9, an alternative means of equalizing the exposed surface areas of inlet and outlet surface of a piston head is shown. Cylinder actuator 325 includes a first section 325a defining an inlet chamber 327a and a second section 325b defining an outlet chamber 327b. A piston 328 includes a first piston head 328a received within inlet chamber 327a and a second piston head 328b received within outlet chamber 327b. First and second piston heads 328a, 328b are connected by a shaft 329. Shaft 329 may extend through second piston head 328b, or instead a second shaft may extend distally from second piston head 328b. Inlet and outlet chambers 327a, 327b and first and second piston head 328a, 328b are sized such that the surface area on the inlet side of first piston head 328a is equal to the exposed surface area on the outlet side of second piston head 328b, i.e., the surface area of second piston head 328b minus the surface are covered by shaft 329. In this manner, the coasting experienced in applicator assembly 50 as a result of cylinder actuator 325 during use of an actuator assembly including cylinder actuator 325 is eliminated or nearly eliminated.

Although the illustrative embodiments of the present disclosure have been described herein with reference to the accompanying drawings, it is to be understood that the disclosure is not limited to those precise embodiments, and that various other changes and modifications may be effected therein by one skilled in the art without departing from the scope or spirit of the disclosure.

What is claimed is:

1. An actuator assembly comprising:
housing configured for operable engagement by a user;
a trigger assembly operably supported on the housing;
a gas cartridge releasably secured to the housing;
a valve housing mounted within the housing for controlling the flow of pressurized gas through the housing; and
a cylinder actuator including a piston selectively extendable therefrom configured for depressing a plunger, the piston including a head having an inlet surface disposed within an inlet chamber of the cylinder actuator and an outlet surface disposed within the outlet chamber of the cylinder actuator, wherein the exposed surface area of the first surface is equal to the exposed surface of the second surface.

2. The actuator assembly of claim 1, wherein the piston includes a first shaft extending from the inlet surface of the head and a second shaft extending from the outlet surface of the head.

3. The actuator assembly of claim 1, wherein the piston includes a shaft extending through the head such that the shaft extends from both the inlet and outlet surfaces of the head.

4. The actuator assembly of claim 1, wherein the cylinder actuator includes first and second sections and the piston includes a first head disposed within the first section and a second head disposed within the second section, a first shaft extends between the first and second heads and second shaft extends from the second head, wherein an exposed surface area of the first head is equal to an exposed surface area of the second head.

5. The actuator assembly of claim 1, wherein the housing is configured for operable connection with an applicator assembly.

6. The actuator assembly of claim 1, wherein the valve housing includes at least a first actuator valve and at least a first dispense on/off valve.

7. The actuator assembly of claim 6, wherein the valve housing further includes at least one solenoid valve.

8. The actuator assembly of claim 1, wherein the housing includes a pencil grip.

9. The actuator assembly of claim 1, wherein the housing includes a pistol grip.

10. A system comprising:
an applicator assembly including at least a first syringe, wherein the at least first syringe includes plunger; and
an actuator assembly operably connected to the applicator assembly, wherein the actuator assembly includes a cylinder actuator including a piston selectively extendable therefrom for depressing the plunger, the piston including a head having an inlet surface disposed within an inlet chamber of the cylinder actuator and an outlet surface disposed within the outlet chamber of the cylinder actuator, wherein the exposed surface area of the first surface and the second surface are equal.
